(19) United States
(12) Patent Application Publication
(10) Pub. No.: US 2026/0024364 A1
(43) Pub. Date: Jan. 22, 2026

(54) IMAGING APPARATUS, METHOD FOR CONTROLLING IMAGING APPARATUS, AND NON-TRANSITORY COMPUTER READABLE MEDIUM

(71) Applicant: CANON KABUSHIKI KAISHA, Tokyo (JP)

(72) Inventor: NAOHIKO TSUCHIDA, Tokyo (JP)

(21) Appl. No.: 19/250,671

(22) Filed: Jun. 26, 2025

(30) Foreign Application Priority Data
Jul. 16, 2024 (JP) 2024-113265

(51) Int. Cl. G06V 20/70; G06V 10/774; H04N 23/63

(52) U.S. Cl. CPC G06V 20/70; G06V 10/774; H04N 23/632

(57) ABSTRACT

An imaging apparatus executes reception processing in which annotation information related to an image is received, executes first display control processing in which a live view image is displayed on a display unit, executes second display control processing in which the annotation information received by the reception processing is associated with the live view image and displayed on the display unit, executes imaging processing in which a captured image is generated, executes input processing in which a selection operation for selecting the annotation information displayed on the display unit is accepted, and executes data generation processing in which annotation data, in which the annotation information selected by the selection operation and the captured image generated by imaging processing are associated, is generated.

### BACKGROUND

### Field of the Technology

The present disclosure relates to an imaging apparatus, a method for controlling the imaging apparatus, and a non-transitory computer readable medium.

### Description of the Related Art

Generally, when AI (Artificial Intelligence) is used to perform processing such as image recognition, machine learning is required, so it is necessary to prepare training data used for training. In addition, there are cases where training data is created by adding information called annotation information, which assigns meaning to an image, to image data that serves as the basis for the training data.

In recent years, with the development of AI, there has also been an increasing demand for training data used in AI learning. However, a shortage of image data that serves as the basis for training data and a shortage of annotators who are operators performing annotation information operations will lead to a chronic shortage of training data used in AI learning, which has become a problem.

Therefore, in Japanese Patent Laid-Open No. 2021-157404, it is proposed to create training data for AI learning by adding annotation information to a synthesized image. In addition, in Japanese Patent Laid-Open No. 2021-68450, it is proposed to promote the creation of training data for AI learning by providing a method that limits the complexity of adding annotation information.

However, these do not fundamentally solve the problems such as the shortage of image data (images for annotation) that serves as the basis for training data and the shortage of annotators mentioned above, and in view of the recent spread of AI technology, a prompt resolution of the problems mentioned above is highly desirable.

In general, companies that provide annotation information receive annotation requests from companies developing AI and acquire, from the Internet, data servers, etc., images related to annotation information suitable for the requests. It is considered that tens of thousands to hundreds of thousands of images for annotation are required for AI learning.

Therefore, in the case where there is a shortage of images for annotation, it is necessary to separately secure images that satisfy the requests, such as by capturing new photographs, which raises concerns about the burden of acquiring images for annotation.

### SUMMARY

The present disclosure has been made in view of the above, and provides technology for reducing a shortage of annotation data and the workload associated with the acquisition of annotation data.

According to some embodiments, an imaging apparatus includes a processor, and a memory storing a program which, when executed by the processor, causes the imaging apparatus to execute reception processing in which annotation information related to an image is received, execute first display control processing in which a live view image is displayed on a display unit, execute second display control processing in which the annotation information received by the reception processing is associated with the live view image and displayed on the display unit, execute imaging processing in which a captured image is generated, execute input processing in which a selection operation for selecting the annotation information displayed on the display unit is accepted, and execute data generation processing in which annotation data, in which the annotation information selected by the selection operation and the captured image generated by imaging processing are associated, is generated.

According to some embodiments, a method for controlling an imaging apparatus includes a reception step of receiving annotation information related to an image, a display step of displaying a live view image on a display unit, a display control step of associating the annotation information received in the reception step with the live view image so as to be displayed on the display unit, an imaging step of generating a captured image, a step of accepting a selection operation for selecting the annotation information displayed on the display unit, and a data generation step of generating annotation data, in which the annotation information selected by the selection operation and the captured image generated in the imaging step are associated.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for explaining the functions of an information processing system according to a first embodiment.

FIG. 2 is a block diagram schematically showing the configuration of an imaging apparatus according to the first embodiment.

FIG. 3 is a flowchart of the processing executed by the imaging apparatus according to the first embodiment.

FIG. 4A to FIG. 4C are diagrams schematically showing display examples on the imaging apparatus according to the first embodiment.

### DESCRIPTION OF THE EMBODIMENTS

Hereinafter, embodiments for implementing the present disclosure will be described in detail with reference to the attached drawings. Note that the embodiments to be described below are examples of realization means of the present disclosure, and may be appropriately modified or changed according to a configuration or various conditions of an apparatus to which the present disclosure is applied. In addition, it is also possible to appropriately combine the respective embodiments.

### First Embodiment

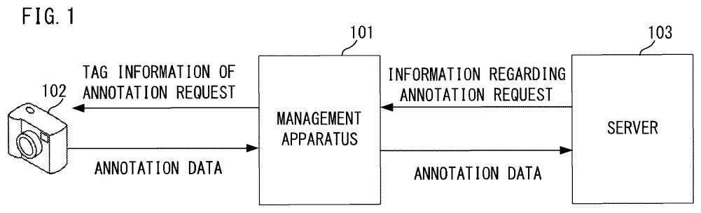

An imaging apparatus according to a first embodiment of the present disclosure will be described. FIG. 1 is a block diagram showing a configuration example of an information processing system 1 having an imaging apparatus 102 of this embodiment. Note that here, a digital camera is assumed as an example of the imaging apparatus, but the imaging apparatus is not limited to this. The imaging apparatus according to this embodiment may be a communication apparatus such as a portable tablet device, a personal computer, and the like.

FIG. 1 is a diagram schematically showing an outline configuration of an information processing system 1 according to this embodiment. As shown in FIG. 1, the information processing system 1 includes a management apparatus 101, an imaging apparatus 102, and a server 103.

The management apparatus 101 has a function as a server that manages annotation requests in this embodiment and information related to the processing of images (images for annotation) that satisfy the annotation requests. The management apparatus 101 acquires information regarding an annotation request from the server 103 managed by an AI development company that provides an annotation request concerning images for annotation. The information of the annotation request includes various conditions for specifying an object depicted in an image according to a request from the AI development company regarding images used in AI learning. In addition, the information of the annotation request includes feature information regarding the features of a subject photographed in an image and imaging conditions of the image used in AI learning. For example, when the subject is a person, the feature information regarding the features of the subject includes information such as the subject's gender, age, height, physique, facial expression and the like.

The management apparatus 101 transmits the information of the annotation request acquired from the server 103 to the imaging apparatus 102. In addition, the management apparatus 101 receives, from the imaging apparatus 102, annotation data including a captured image (an image for annotation) imaged by the imaging apparatus 102 and tag information (annotation information) described below, and manages the received annotation data. The management apparatus 101 generates a data set by using images for annotation when the conditions requested by the AI development company as a data set for AI learning are satisfied, for example, the number of images for annotation received from the imaging apparatus 102 reaches a predetermined number. Then, the management apparatus 101 transmits the generated data set to the server 103.

The imaging apparatus 102 receives the information of the annotation request of the AI development company acquired by the management apparatus 101 from the server 103, and displays the received information as tag information together with a live view image on a display unit. In addition, the imaging apparatus 102 accepts the selection of the tag information displayed on the display unit from a user of the imaging apparatus 102, and associates the selected tag information with the captured image. Then, the imaging apparatus 102 transmits the tag information and the captured image, which are associated with each other, as annotation data to the management apparatus 101.

In this embodiment, the imaging apparatus 102 receives the information of the annotation request managed by the management apparatus 101, and displays the information as tag information together with the live view image. This allows the user of the imaging apparatus 102 to understand in real time the annotation request from the AI development company that manages the server 103 as the tag information of the live view image. Then, as the user knows the annotation request from the AI development company at the time of capturing an image, he/she can capture the subject in accordance with the annotation request or re-capture the subject to satisfy the request. As a result, according to the imaging apparatus 102 of this embodiment, the collection of images for annotation can be realized more efficiently than before, and the possibilities of a shortage of images for annotation and a shortage of annotators can be reduced. Note that it is assumed that in this embodiment the captured image acquired by the imaging apparatus 102 is acquired by using still-image data or video data.

In FIG. 1, the imaging apparatus 102 and the server 103 are each represented as a single unit, but in the information processing system 1, a plurality of imaging apparatuses and/or servers may be connected to the management apparatus 101. In addition, the management apparatus 101 determines whether or not the image received from the imaging apparatus 102 satisfies the annotation request received from the server 103. This determination may be made by the user of the management apparatus 101 visually checking the image instead of being executed by the management apparatus 101. The management apparatus 101 may also make the determination by using AI. Thus, the management apparatus 101 can prevent images that do not satisfy annotation requests from being mixed into the annotation data.

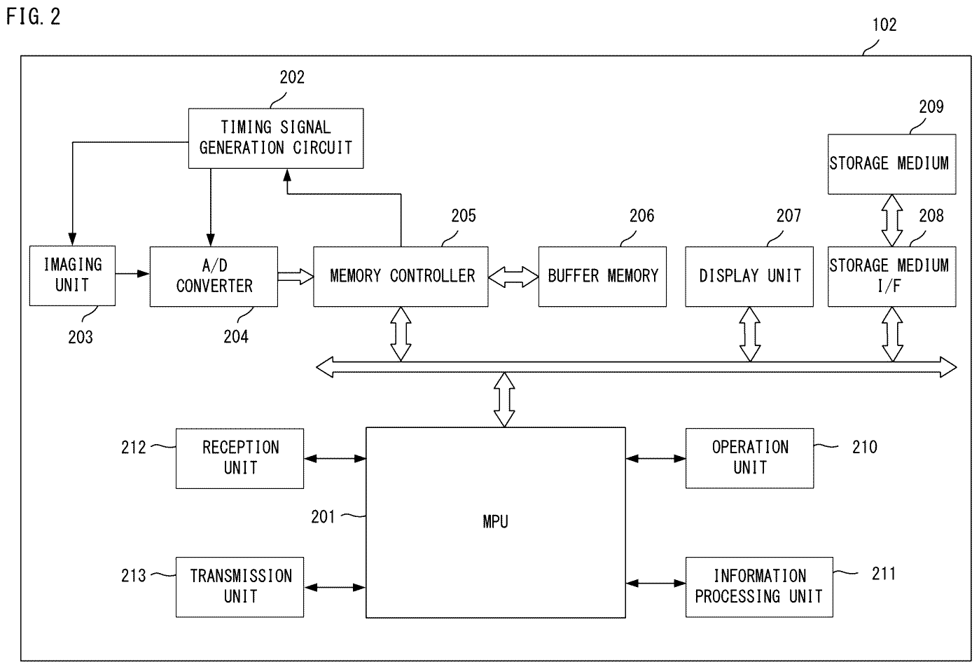

FIG. 2 is a block diagram schematically showing the configuration of the imaging apparatus 102 of FIG. 1. Note that the configuration shown in FIG. 2 is merely an example, and is not used to limit the configuration of the imaging apparatus 102 of this embodiment. As shown in FIG. 2, the imaging apparatus 102 includes an MPU (Micro Processor Unit) 201, a timing signal generation circuit 202, an imaging unit 203, an A/D converter 204 and a memory controller 205. The imaging apparatus 102 further includes a buffer memory 206, a display unit 207, a storage medium I/F 208, a storage medium 209, an operation unit 210, an information processing unit 211, a reception unit 212 and a transmission unit 213.

In this embodiment, the imaging apparatus 102 is an electronic device such as a camera like a digital camera or a digital video camera, or a mobile phone equipped with a camera function or a computer with a camera.

The MPU 201 is a microcontroller for controlling regarding the processing of each unit of the imaging apparatus 102 such as an imaging sequence. The MPU 201 controls processing such as receiving the information of the annotation request of the AI development company received from the server 103, displaying the live view image and the tag information on the display unit 207, associating the captured image with the tag information, and transmitting the annotation data. Note that instead of the MPU 201 controlling the entire apparatus, the entire apparatus may be controlled by a plurality of pieces of hardware sharing processing.

The timing signal generation circuit 202 generates a timing signal necessary for operating the imaging unit 203. The imaging unit 203 includes, for example, an optical lens unit, an optical system that performs optical control, such as aperture, zoom, focal length, and the like, and an image sensor that converts light (video) entering the apparatus through the optical lens unit into an electrical video signal. A CMOS (Complementary Metal Oxide Semiconductor) or a CCD (Charge Coupled Device) is used as an image sensor. The imaging unit 203, under the control of the MPU 201, converts subject light formed by a lens that is included in the imaging unit 203 into an electrical signal by an image sensor, and outputs digital data, obtained by performing noise reduction processing or the like, as image data.

The A/D converter 204 converts analog image data that is read out from the imaging unit 203 into digital image data. The memory controller 205 temporarily stores the tag information to be displayed on the display unit 207, and controls the reading and writing of the memory, a refresh operation of the buffer memory 206, and the like. The buffer memory 206 stores the captured image data. The display unit 207 displays the tag information and the image data stored in the buffer memory 206. The storage medium I/F 208 is an interface for controlling the reading of data from and the writing of data to the storage medium 209. The storage medium 209 is a memory card, a hard disk, and the like, and stores programs for the processing executed in the imaging apparatus 102 and data necessary for the processing.

The operation unit 210 is an input unit that receives an instruction from a user concerning the selection of annotation information when the tag information is associated with a captured image. The operation unit 210 may be, for example, a physical button or a button displayed on a touch panel. The information processing unit 211 associates the captured image with the tag information. The tag information may be associated with the captured image as meta information in, for example, EXIF (Exchangeable Image File Format) or may be directly embedded in the image data of the captured image. The reception unit 212 and the transmission unit 213 are connected to the Internet and transmit data to and receive data from an external apparatus such as the management apparatus 101. The information of the annotation request acquired by the reception unit 212 is displayed on the display unit 207 as tag information together with the image via the MPU 201. Note that the reception unit 212 may also receive tag information from the management apparatus 101. The captured image that has been associated with the tag information by the information processing unit 211 is transmitted as the annotation data from the transmission unit 213 to the management apparatus 101.

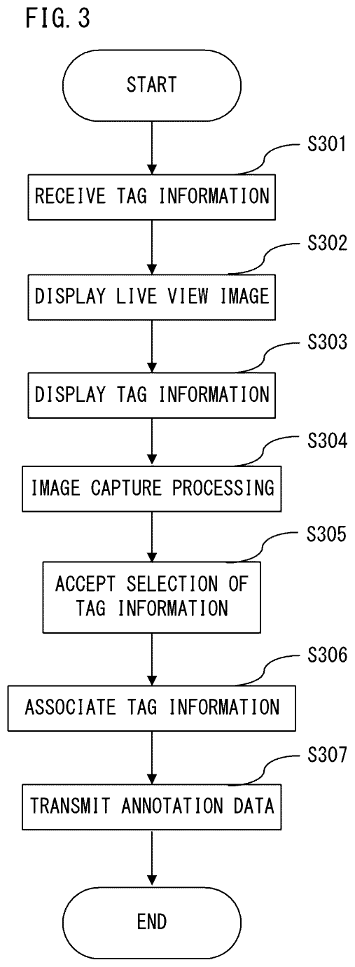

Next, an example of the processing executed by the imaging apparatus 102 of this embodiment will be described. FIG. 3 is a flowchart showing an example of the procedure for the processing executed by the imaging apparatus 102. The processing in FIG. 3 is realized by the MPU 201 of the imaging apparatus 102 expanding and executing the programs stored in the storage medium 209. The processing shown in FIG. 3 is executed when the imaging apparatus 102 receives an operation regarding the start of imaging, such as the user pressing an imaging button of the imaging apparatus 102.

In step S301, the MPU 201 causes the reception unit 212 to acquire tag information from the management apparatus 101. Note that the acquisition of tag information by the MPU 201 may be performed constantly or may be performed in response to receiving a processing start instruction based on an input from the operation unit 210.

Next, in step S302, the MPU 201 executes first display control processing, in which the imaging unit 203 converts light received from a subject into an electrical signal to execute imaging processing, generates a live view image, and displays the live view image on the display unit 207.

Then, in step S303, the MPU 201 displays the tag information together with the live view image on the display unit 207 using the tag information concerning the annotation request acquired by the reception unit 212 in step S301. Here, the MPU 201 is a display control unit that executes second display control processing in which the annotation information received by the reception unit is associated with the live view image and displayed on the display unit.

Next, in step S304, the MPU 201 controls the imaging unit 203 according to the user's operation on the operation unit 210, and performs imaging processing to generate a captured image.

Then, in step S305, the MPU 201 accepts the user's selection of the tag information displayed on the display unit 207 in step S303. Note that the user's selection of the tag information in step S305 may be performed before the imaging of an image in step S304. In such case, the flowchart in FIG. 3 will be modified so that the processing in step S304 is executed after step S305.

Next, in step S306, the MPU 201 causes the information processing unit 211 to associate the tag information selected in step S305 with the captured image. The MPU 201 then generates annotation data that includes images and tag information that satisfy the annotation request received by the management apparatus 101 from the server 103. Here, the MPU 201 is a data generation unit that generates annotation data in which the annotation information selected by the selection operation and the captured image generated by the imaging unit are associated.

Then, in step S307, the MPU 201 causes the transmission unit 213 to transmit the annotation data generated in step S306 to the management apparatus 101. The MPU 201 then ends the processing of this flowchart. Note that the MPU 201 may apply encryption processing to the data transmitted in step S307, or may additionally execute processing for associating the transmitted data with a block chain.

In this way, in this embodiment, the imaging apparatus 102 displays the annotation request together with the live view image as the tag information, allowing the user to be aware of the annotation request in real time at the time of imaging.

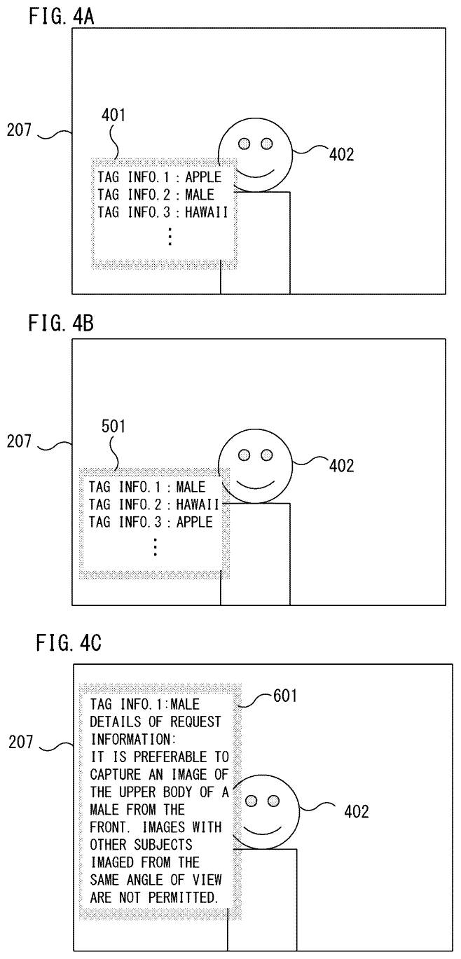

FIG. 4A to FIG. 4C schematically show concrete examples of images and tag information displayed on the display unit 207 by the above-mentioned processing of the imaging apparatus 102 in this embodiment.

In the display example shown in FIG. 4A, tag information 401 and a subject 402 of a live view image are displayed on the display unit 207. Here, it is assumed that the subject 402 is a male. As shown in FIG. 4A, the tag information 401 is superimposed on the subject 402 subjected to live view display on the display unit 207, allowing the user to check the tag information in real time without interfering with his/her photography. In addition, in the example of FIG. 4A, the background of the display area of the tag information 401 is displayed in a transparent manner, so that the subject 402 is not blocked by the display area of the tag information 401, and an improvement in the usability of the user's photography can be expected. Note that the transparency of the background of the display area of the tag information 401 can be set as appropriate.

In addition, in the example of FIG. 4A, the user can recognize that the tag information 401 includes the information “Tag Information 2: Male” when capturing the subject 402. Thus, after capturing the subject 402, the user can operate the operation unit 210 to select “Tag Information 2: Male”, enabling the association of the captured image of the captured subject 402 with the selected tag information. In this way, the user can recognize the annotation request of the AI development company, which is the provider of the tag information, from the tag information in real time at the time of imaging. As a result, for example, when a male subject and a female subject are displayed on a live view screen, the user can select the male subject on the basis of the tag information. Therefore, by the processing of the flowchart of this embodiment, which cannot be realized in the prior art, the user can capture an image that satisfies the annotation request.

Moreover, in this embodiment, the order of the individual pieces of tag information displayed on the display unit 207 is changed according to the subject photographed in the live view image. The MPU 201 acquires subject information of a subject displayed on the display unit 207, and sorts, on the basis of the acquired subject information, a plurality of pieces of tag information in descending order of relevance to the subject. As a concrete example, the MPU 201 can estimate, by using conventional image recognition technology, the features (such as gender, age, height, physique, facial expression) of the subject displayed on the display unit 207, and acquire an estimation result and take same as the subject information. Here, the MPU 201 is a specifying unit that specifies a subject photographed in a live view image.

FIG. 4B shows a display example in which the MPU 201 sorts the tag information displayed on the display unit 207 in FIG. 4A and displays the sorted tag information on the display unit 207. In FIG. 4B, the MPU 201 performs image recognition using a trained model stored in the storage medium 209 of the imaging apparatus 102, and estimates that the subject 402 displayed on the display unit 207 is a male. Then, on the basis of the estimation result indicating that the subject 402 is a male, the MPU 201 performs sorting in which priority is given to the tag information “Tag Information 2: Male” over other tag information from among the Tag Information 1, 2, 3, etc. that make up the tag information 401. The MPU 201 then changes the tag information “Tag Information 2: Male” to the tag information “Tag Information 1: Male”. As a result, the post-change tag information 501 is displayed on the display unit 207. Thus, the tag information “Male”, which has a stronger association with the subject 402, is preferentially displayed on the display unit 207.

Therefore, according to this embodiment, even when various pieces of tag information are displayed in a list on the display unit 207, the user can more easily select the tag information that is more likely to be associated with the subject. Note that in this embodiment, the MPU 201 may sort the tag information so as to preferentially display the latest piece of tag information, that is, the tag information with a more recent acquisition date and time, from among the individual pieces of tag information that make up the tag information. In addition, the MPU 201 may sort the tag information using location information such as the current location of the user so that the tag information with a higher relevance to the current location is preferentially displayed.

In this embodiment, the MPU 201 generates, for example, training data that includes input images, which are images of a subject with different features captured by any imaging apparatus, and correct answer data, which is information indicating the features of the subject, and generates a training data set consisting of a plurality of groups of the training data. Then, the MPU 201 uses the training data set to train a learning model that estimates the subject from the live view image displayed on the display unit 207. The MPU 201 saves the trained model obtained by the training of a learning model in the storage medium 209. In this embodiment, a CNN (Convolutional Neural Network) is used to construct the learning model. For example, known networks such as VGG 16 and Dense Net may be used. Note that the MPU 201 may acquire a trained model, on which the above-mentioned training of the learning model has been performed, from an external source in advance before the start of the flowchart in FIG. 3, and saves same in the storage medium 209.

Note that in this embodiment, it is assumed that the trained model is obtained by the training of a learning model that estimates the features of a person as the subject. However, the subject is not limited to a person; various objects such as animals, buildings, mountains, forests and oceans can be subjects, and a trained model may be acquired by training a learning model that estimates the features of each respective subject.

In addition, in this embodiment, it is assumed that an estimator based on deep learning, such as a CNN, is used as an estimator for realizing a learning model. However, for the learning model according to this embodiment, an estimator based on deep learning other than a CNN, such as a Visual Transformer, may be used. Alternatively, for the learning model according to this embodiment, an estimator based on a known machine learning method other than deep learning, such as regression using Random Forest or Adaboost, may be used.

In addition, in this embodiment, among the tag information displayed on the display unit 207, information related to the imaging of the subject at the time of imaging by the user may be displayed. FIG. 4C shows that the details of the annotation request of the AI development company acquired by the management apparatus 101 from the server 103 are displayed as the tag information related to the subject 402 displayed on display unit 207 in FIG. 4A. In the example of FIG. 4C, as shown in FIG. 4A and FIG. 4B, only “Male” is displayed as the tag information, and the angle of view and imaging conditions at the time of imaging are unknown, which means that there is a possibility that even if the image is captured by the user, same may not be used as the image desired by the AI development company.

Therefore, for example, when the user operates the operation unit 210 to select “Tag Information 2: Male” in FIG. 4A, or when the user operates the operation unit 210 to select “Tag Information 1: Male” in FIG. 4B, the MPU 201 displays the details of the tag information. FIG. 4C shows an example of the detailed display of the tag information displayed on the display unit 207. As shown in FIG. 4C, tag information 601 that includes the photography conditions “It is preferable to capture an image of the upper body of a male from the front. Images with other subjects photographed from the same angle of view are not permitted.” is displayed on the display unit 207 as the details of the tag information “Male”. The detailed information displayed in the tag information 601 can be generated on the basis of the information of the annotation request acquired by the management apparatus 101 from the server 103. In this way, in this embodiment, the detailed imaging conditions and requests for the subject are displayed on the display unit 207 as the tag information, allowing the user to understand how to capture the subject 402 in terms of the angle of view and conditions.

As above, while the present disclosure has been described in detail on the basis of preferred embodiments thereof, the present disclosure is not limited to these specific embodiments, and various forms in the range not departing from the concept of the present disclosure also belong to the present disclosure. Some of the embodiments described above may be combined as appropriate. In addition, the present disclosure also includes a case in which a software program that realizes the functions of the embodiment described above is supplied to a system or device having a computer capable of executing the program directly from a storage medium or using wired/wireless communication, and the program is executed. Thus, the functional processing of the present disclosure is realized by a computer, and thus a program code that is supplied to and installed in this computer realizes the present disclosure as well. In other words, the computer program itself for realizing the functional processing of the present disclosure is also included in the present disclosure. In such a case, the form of the program such as an object code, a program executed by an interpreter, or script data supplied to the OS is arbitrary, as long as it has the functions of the program. A storage medium for supplying the program may be, for example, a magnetic storage medium such as a hard disk or a magnetic tape, an optical/magneto optical storage medium, or a nonvolatile semiconductor memory. In addition, as a method for supplying a program, a method in which a computer program forming the present disclosure is stored in a server on a computer network, and a connected client computer downloads the computer program and sets the computer program as a program may be also considered.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present disclosure, technology for reducing a shortage of annotation data and the workload associated with the acquisition of annotation data can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113265, filed on Jul. 16, 2024, which is hereby incorporated by reference herein in its entirety.

What is claimed is:

1. An imaging apparatus, comprising:
a processor; and
a memory storing a program which, when executed by the processor, causes the imaging apparatus to
execute reception processing in which annotation information related to an image is received,
execute first display control processing in which a live view image is displayed on a display unit,
execute second display control processing in which the annotation information received by the reception processing is associated with the live view image and displayed on the display unit,
execute imaging processing in which a captured image is generated,
execute input processing in which a selection operation for selecting the annotation information displayed on the display unit is accepted, and
execute data generation processing in which annotation data, in which the annotation information selected by the selection operation and the captured image generated by imaging processing are associated, is generated.

2. The imaging apparatus according to claim 1, wherein the program, when executed by the processor, further causes the imaging apparatus to
execute specifying processing in which a subject photographed in the live view image is specified, and wherein
in the second display control processing, a plurality of pieces of the annotation information are sorted in descending order of relevance to the subject specified by the specifying processing and displayed on the display unit.

3. The imaging apparatus according to claim 2, wherein in the specifying processing, the subject photographed in the live view image is specified on the basis of an estimation result of the subject by using a trained model obtained by training a learning model, which estimates the subject photographed in the live view image by using training data that includes input images and correct answer data, which is information of the subject in the input images.

4. The imaging apparatus according to claim 1, wherein the annotation information includes feature information regarding features of the subject photographed in the live view image and imaging conditions, and
in the second display control processing, the imaging conditions are displayed together with the feature information on the display unit.

5. An information processing system, comprising:
the imaging apparatus according to claim 1; and
a management apparatus configured to receive the annotation data from the imaging apparatus.

6. A method for controlling an imaging apparatus, the method comprising:
a reception step of receiving annotation information related to an image;
a display step of displaying a live view image on a display unit;
a display control step of associating the annotation information received in the reception step with the live view image so as to be displayed on the display unit;
an imaging step of generating a captured image;
a step of accepting a selection operation for selecting the annotation information displayed on the display unit; and
a data generation step of generating annotation data, in which the annotation information selected by the selection operation and the captured image generated in the imaging step are associated.

7. A non-transitory computer readable medium that stores a program, wherein the program causes a computer to execute a control method of an imaging apparatus, the control method comprising:
a reception step of receiving annotation information related to an image;
a display step of displaying a live view image on a display unit;
a display control step of associating the annotation information received in the reception step with the live view image so as to be displayed on the display unit;
an imaging step of generating a captured image;
a step of accepting a selection operation for selecting the annotation information displayed on the display unit; and
a data generation step of generating annotation data, in which the annotation information selected by the selection operation and the captured image generated in the imaging step are associated.
